(19) United States
(12) Patent Application Publication
(10) Pub. No.: US 2018/0044571 A1
(43) Pub. Date: Feb. 15, 2018

(54) COMBINED USES OF A PHOSPHOROUS COMPOUND FOR IRON SULPHIDE DISSOLUTION AND BACTERIAL CONTROL

(71) Applicant: RHODIA OPERATIONS, Paris (FR)

(72) Inventors: Chris JONES, Walsall (GB); Stéphanie EDMUNDS, West Midlands (GB); Alan Christopher FELLOWS, Dudley (GB); Gareth COLLINS, Fulshear, TX (US)

(73) Assignee: RHODIA OPERATIONS, Paris (FR)

(21) Appl. No.: 15/672,379

(22) Filed: Aug. 9, 2017

Related U.S. Application Data
(60) Provisional application No. 62/372,904, filed on Aug. 10, 2016.

(51) Int. Cl. C09K 8/528; E21B 37/06; C11D 7/36; C23F 11/167

(52) U.S. Cl. CPC C09K 8/528; C23F 11/167; E21B 37/06; C11D 7/36; C09K 2208/20; C02F 2101/203

(57) ABSTRACT

A process for simultaneously dissolving iron sulphide and killing or inhibiting bacteria comprising the steps of continuously adding or shot dosing to a hydrocarbon-containing system, an aqueous fluid comprising a formulation comprising tris(hydroxymethyl) phosphine or tetrakis (hydroxymethyl) phosphonium salt.

### CROSS-REFERENCE TO RELATED APPLICATION

The present application claims the benefit of priority under 35 U.S.C. § 119(e) of U.S. Provisional Application Ser. No. 62/372,904, filed on Aug. 10, 2016, the entire disclosure of which is incorporated herein by reference.

### BACKGROUND

Tris(hydroxymethyl) phosphine, commonly known as THP and its derived salts, including tetrakis (hydroxymethyl) phosphonium salt, generally abbreviated as THPS, are known as biocidical products. It is also well known that formulations containing THP or THPS can dissolve iron sulphides.

In the oil and gas industry, these formulations are frequently used ‘either’ as iron sulphide dissolvers or as biocides to control troublesome bacteria. It has been widely accepted that when THPS dissolves iron sulphide, its ability to provide bacterial control is either reduced or sacrificed completely. This belief has now been discovered to be an untrue prejudice.

### BRIEF DESCRIPTION OF THE DRAWINGS

FIG. 1 shows the samples of formulation 1 containing 2000 ppm THPS active ingredient after 1 hour contact time;

FIG. 2 shows the samples of formulation 2 containing 2000 ppm THPS active ingredient after 1 hour contact time;

FIG. 3 shows the samples of formulation 2 containing 50 ppm THPS active ingredient after 1 hour contact time;

FIG. 4 provides results for the samples of formulation 1 containing 2000 ppm THPS active ingredient after 1 hr contact time;

FIG. 5 provides results for the samples of formulation 2 containing 2000 ppm THPS active ingredient after 1 hr contact time;

FIG. 6 provides results for the samples of formulation 2 containing 50 ppm THPS active ingredient after 1 hr contact time;

FIG. 7 is a plot of surviving bacteria versus contact time for studies with formulation 1;

FIG. 8 is a plot of surviving bacteria versus contact time for studies with formulation 2 (FeS dissolution carried out at 2000 ppm and biocidal efficacy using solutions diluted to 50 ppm active ingredient THPS);

FIG. 9 is a plot of surviving bacteria versus contact time for studies with formulation 2;

FIG. 10 provides results for the samples of formulation 1 containing 2000 ppm THPS active ingredient after 1 hour contact time;

FIG. 11 provides results for the samples of formulation 2 containing 2000 ppm THPS active ingredient after 1 hour contact time; and

FIG. 12 provides results for the samples of formulation 2 containing 50 ppm THPS active ingredient after 1 hour contact time.

### SUMMARY

The present disclosure provides a process for simultaneously dissolving iron sulphide and killing or inhibiting bacteria present in a hydrocarbon-containing system. In an embodiment, the process includes the step of introducing to the system an aqueous fluid comprising tris(hydroxymethyl) phosphine (THP) or tetrakis (hydroxymethyl) phosphonium salt (THPS), wherein the THP or THPS is introduced in a molar ratio of 1:1 to 6:1 THP or THPS to iron sulphide. In an embodiment, the molar ratio ranges from 2:1 to 5:1. In another embodiment, the molar ratio ranges from 3:1 to 4:1.

In an embodiment, the aqueous fluid is introduced to the system via continuous addition. In another embodiment, the aqueous fluid is introduced to the system via shot dosing.

In an embodiment, the bacteria are selected from sulphate-reducing prokaryotes, general heterotrophic bacteria, acid producing bacteria, nitrate-reducing bacteria, and methanogenic archaea.

In an embodiment, the iron sulphide is selected from troilite (FeS), pyrite (FeS₂), mackinawite (Fe₉S₈), phyrrhotite (Fe₇S₈), schmoo, and combinations thereof.

In an embodiment, the aqueous fluid includes tetrakis (hydroxymethyl) phosphonium salt which has formula THPX, wherein X is chloride, sulphate, bromide, iodide, phosphate, acetate, oxalate, citrate, borate, chlorate, lactate, nitrate, fluoride, carbonate or formate.

In an embodiment, the aqueous fluid further comprises a biopenetrant, a corrosion inhibitor, or a combination thereof. In an embodiment, the aqueous fluid includes from 0.05 wt % to 25 wt % of a biopenetrant, a corrosion inhibitor, or a combination thereof. In an embodiment, the biopenetrant and/or corrosion inhibitor is selected from phosphonate endcapped biopenetrants which include a polymer of an unsaturated carboxylic acid or a copolymer of an unsaturated carboxylic acid with a sulphonic acid, said polymer or copolymer being terminated by a mono- or diphosphonated unsaturated carboxylic acid group or having such monomers incorporated into the polymer backbone.

In an embodiment, the THP or THPS is introduced to the system at a concentration of from 1 to 3000 ppm based on the total volume of aqueous fluid added to the system. In an embodiment, the concentration ranges from 10 to 1000 ppm. In another embodiment, the concentration ranges from 20 to 300 ppm.

In an embodiment, the hydrocarbon-containing system is (a) an oil reservoir or a gas reservoir, (b) a container for storing or processing oil or gas, or (c) a distribution or transmission pipeline for water or hydrocarbons.

In an embodiment, the process further includes measuring the number of microorganisms and the level of solid iron sulphide species in the system prior to and after introducing the aqueous fluid to the system, wherein after introduction of the aqueous fluid the number of microorganisms is reduced by at least log 2 and at least 60% iron sulphide species is dissolved. In another embodiment, the number of microorganisms is reduced by at least log 3. In another embodiment, at least 70% iron sulphide species is dissolved.

Also provided is the use of a formulation comprising tris(hydroxymethyl) phosphine or a tetrakis (hydroxymethyl) phosphonium salt to simultaneously dissolve iron sulphide and kill or inhibit the activity of micro-organisms, especially bacteria.

### DETAILED DESCRIPTION

The present disclosure demonstrates that THP or THPS can exhibit both properties simultaneously. In particular, when THPS has dissolved iron sulphide it can still exhibit biocidal properties. Preferred stoichiometry between THPS and iron sulphides is also presented. These findings have significant commercial, regulatory and technical implications related to the deployment of THPS-based biocides as opposed to iron sulphide dissolvers and chelants.

In an embodiment, the present disclosure provides the use of a formulation that includes tris(hydroxymethyl) phosphine or a tetrakis (hydroxymethyl) phosphonium salt to simultaneously dissolve iron sulphide and kill or inhibit the activity of micro-organisms, especially bacteria.

Also presented is a process for simultaneously dissolving iron sulphide and killing or inhibiting bacteria that includes the steps of continuously adding or shot dosing to a hydrocarbon-containing system, an aqueous fluid that includes a formulation including tris(hydroxymethyl) phosphine or tetrakis (hydroxymethyl) phosphonium salt.

In an embodiment, addition of the formulation is made at a concentration of from about 1 ppm to about 3000 ppm, based on the total volume of aqueous fluid added to the system. In another embodiment, addition of the formulation is made at a concentration of from about 10 ppm to about 1000 ppm, based on the total volume of aqueous fluid added to the system. In another embodiment, addition of the formulation is made at a concentration of from about 20 ppm to about 300 ppm, based on the total volume of aqueous fluid added to the system.

In an embodiment, the hydrocarbon-containing system is (a) an oil reservoir or a gas reservoir, (b) a container for storing or processing oil or gas, or (c) a distribution or transmission pipeline for water or hydrocarbons.

In an embodiment, bacteria are selected from sulphate-reducing prokaryotes, general heterotrophic bacteria, acid producing bacteria, nitrate-reducing bacteria, methanogenic archaea, and combinations thereof.

In an embodiment, the iron sulphide is selected from troilite (FeS), pyrite (FeS₂), mackinawite (Fe₉S₈), phyrrhotite (Fe₇S₈), schmoo and combinations thereof. As used herein, the term “schmoo” is a catch-all phrase for slimy, oily substances or deposits that adhere to almost any surface it contacts, and which is difficult to remove. Schmoo described herein includes iron sulphides and hydrocarbons in such a composition.

In an embodiment, the formulation includes tetrakis (hydroxymethyl) phosphonium salt which has formula THPX, wherein X is chloride, sulphate, bromide, iodide, phosphate, acetate, oxalate, citrate, borate, chlorate, lactate, nitrate, fluoride, carbonate or formate.

In some embodiments, the formulation further includes a biopenetrant and/or a corrosion inhibitor. In an embodiment, the formulation includes from about 0.05 wt % to about 25 wt % of biopenetrant and/or corrosion inhibitor.

In an embodiment, the biopenetrant and/or a corrosion inhibitor is selected from phosphonate endcapped biopenetrants which include a polymer of an unsaturated carboxylic acid or a copolymer of an unsaturated carboxylic acid with a sulphonic acid, said polymer or copolymer being terminated by a mono- or diphosphonated unsaturated carboxylic acid group or having such monomers incorporated into the polymer backbone.

In an embodiment, the formulation includes a molar ratio of tetrakis (hydroxymethyl) phosphonium salt to iron sulphide ranging from about 1:1 to about 6:1. In another embodiment, the formulation includes a molar ratio of tetrakis (hydroxymethyl) phosphonium salt to iron sulphide ranging from about 2:1 to about 5:1. In another embodiment, the formulation includes a molar ratio of tetrakis (hydroxymethyl) phosphonium salt to iron sulphide ranging from about 3:1 to about 4:1.

Also provided is a method of treating a water system contaminated with microorganisms and iron sulphide species or susceptible to contamination, which method includes the steps of measuring the level of solid iron sulphide species in water, adding to the system an amount of tris(hydroxymethyl) phosphine or a tetrakis (hydroxymethyl) phosphonium salt in a molar ratio of tris(hydroxymethyl) phosphine or a tetrakis (hydroxymethyl) phosphonium salt to solid Fe sulphide from about 1:1 to about 6:1 thereby reducing the number of microorganisms by at least log 2, preferably log 3, and dissolving at least 60% iron sulphide species, preferably 70%.

While specific embodiments are discussed, the specification is illustrative only and not restrictive. Many variations of this disclosure will become apparent to those skilled in the art upon review of this specification.

Unless defined otherwise, all technical and scientific terms used herein have the same meaning as is commonly understood by one of skill in the art to which this specification pertains.

The present disclosure will further be described by reference to the following examples. The following examples are merely illustrative and are not intended to be limiting. Unless otherwise indicated, all percentages are by weight of the total composition.

### EXAMPLE 1

### Preparation of Formulation 1: Generic THPS

Several samples of 75% of tetrakis (hydroxymethyl) phosphonium sulphate (THPS) in 25% of water were prepared in de-aerated ASW at 2000 ppm & 50 ppm active THPS. For the 50 ppm samples, the formulation is buffered to pH 6.1 using acetate buffer.

### EXAMPLE 2

### Preparation of Formulation 2: THPS Plus Phosphonated Polymer

Several samples of 50% active tetrakis (hydroxymethyl) phosphonium sulphate (THPS) with a vinylphosphonic acid-terminated polyacrylate (VPA) of molecular weight about 4000 added as a biopenetrant at a concentration of approximately 1 percent were used to prepare in de-aerated ASW solutions containing 2000 ppm & 50 ppm active THPS. For the 50 ppm samples, the formulation is buffered to pH 6.1 using acetate buffer.

### EXAMPLE 3

### Addition of Iron Sulphide

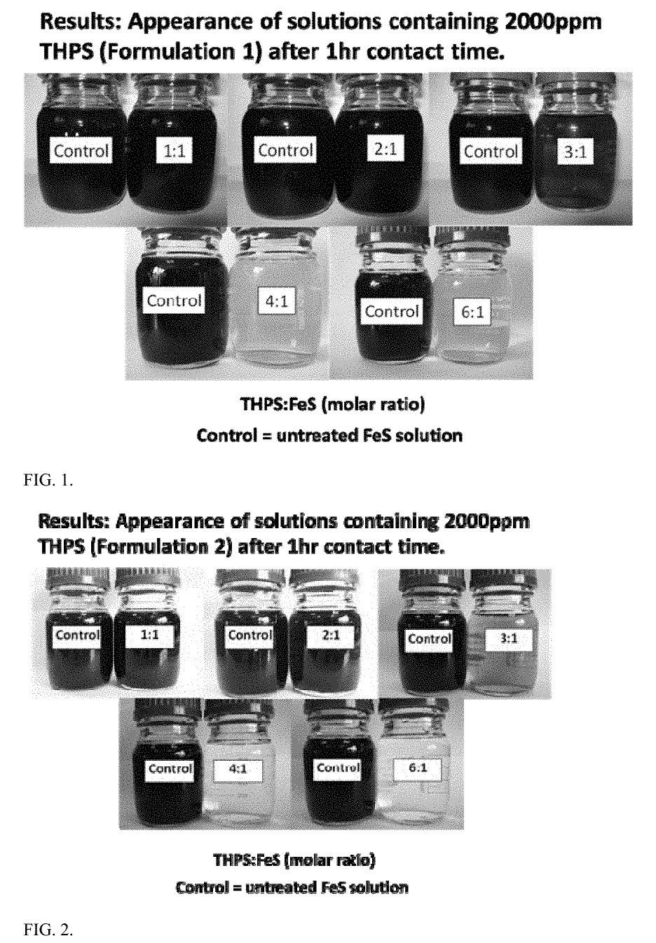

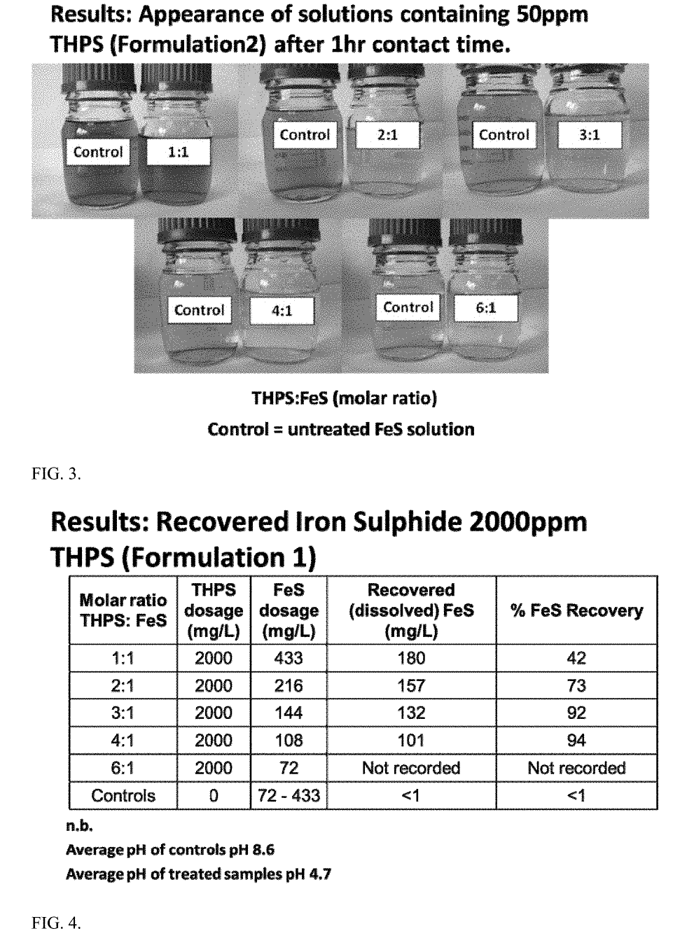

A colloidal solution of iron sulphide was added to each sample of formulation 1 and formulation 2 at an amount calculated to obtain molar ratios of THPS:FeS of 1:1, 2:1, 3:1, 4:1 and 6:1. For each concentration of FeS, control samples were made up without THPS. Once prepared the stock solutions were placed in an incubator at 30° C. and left for a 1 hour contact time. FIG. 1 shows the samples of formulation 1 containing 2000 ppm THPS active ingredient after 1 hour contact time. FIG. 2 shows the samples of formulation 2 containing 2000 ppm THPS active ingredient after 1 hour contact time. FIG. 3 shows the samples of formulation 2 containing 50 ppm THPS active ingredient after 1 hour contact time.

### EXAMPLE 4

### Total Dissolved Iron Content Test

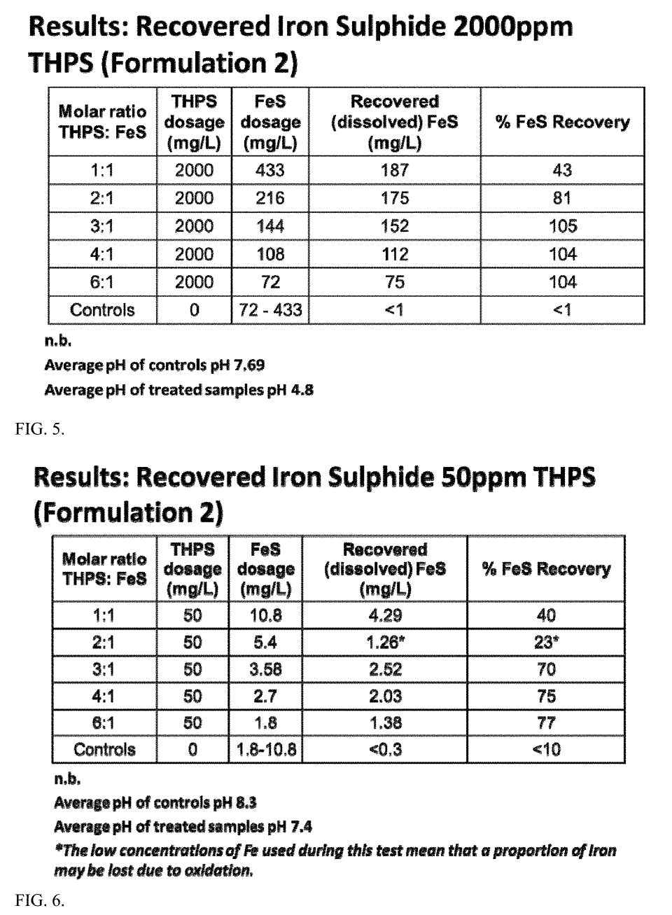

Each sample is filtered and the dissolved iron content quantified in comparison with the control sample without THPS. Results are tabulated in FIGS. 4-6. Good dissolution of the iron sulphide is obtained at treatment ratios of 3:1 and above with the recovered dissolved iron from the iron sulphide representing 70% or above.

### EXAMPLE 5

### Biocidal Efficacy Testing Via Standard Quantitative Suspension Test (QST)

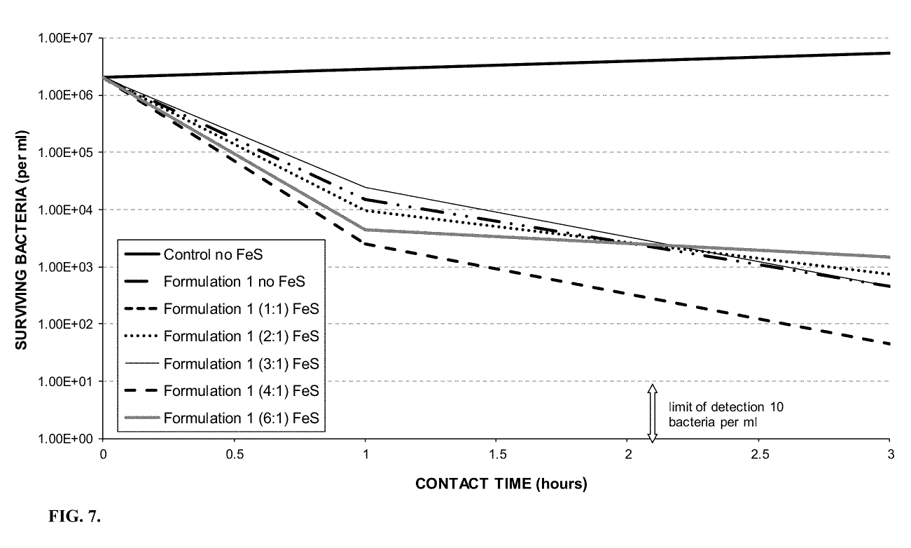

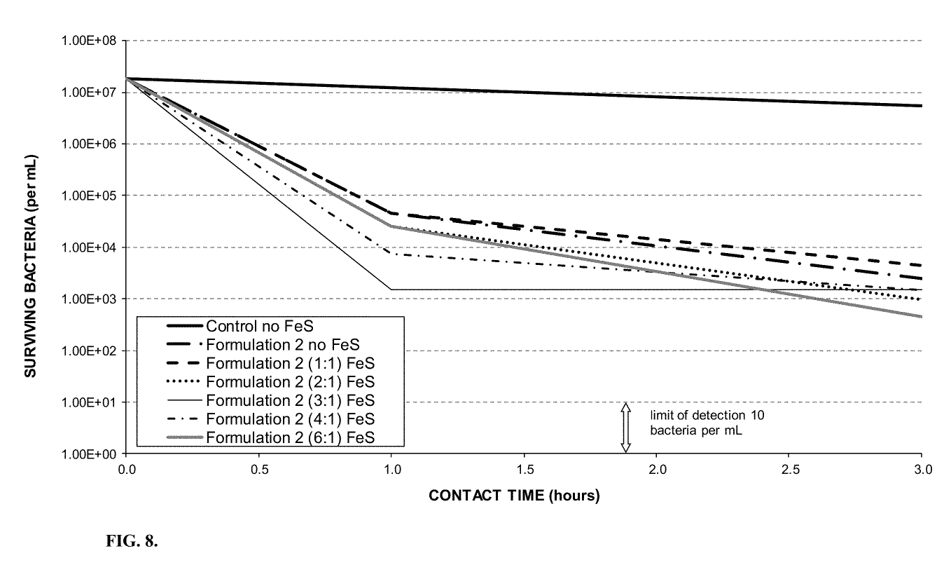

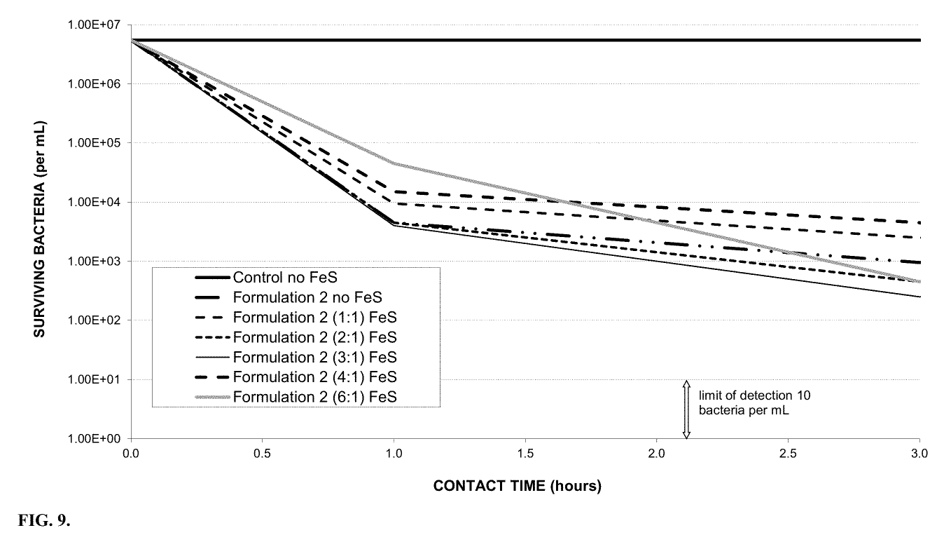

Samples were taken from the 5 dosages of formulation 1 and from the 5 dosages of formulation 2 (at 2000 ppm and 50 ppm as active ingredient) having dissolved iron sulphide and were tested for biocidal efficacy according to standard QST test. Results are provided in FIGS. 7-9, which provide time-kill curves investigating the impact of FeS presence on the efficacy of various formulations versus Pseudomonas aeruginosa ATCC 15442. Tests were run in aerobic conditions at 30° C. in artificial sea water. In all ratios of applied THPS:FeS no significant deterioration in biocidal efficacy is observed compared to the biocidal performance of a THPS solution that has not been contacted with iron sulphide. All results are within the anticipated error of a typical QST biocide efficacy test with a variation of no more than one Log order.

### EXAMPLE 6

### Iron Sulphide Dissolution and Biocial Efficacy

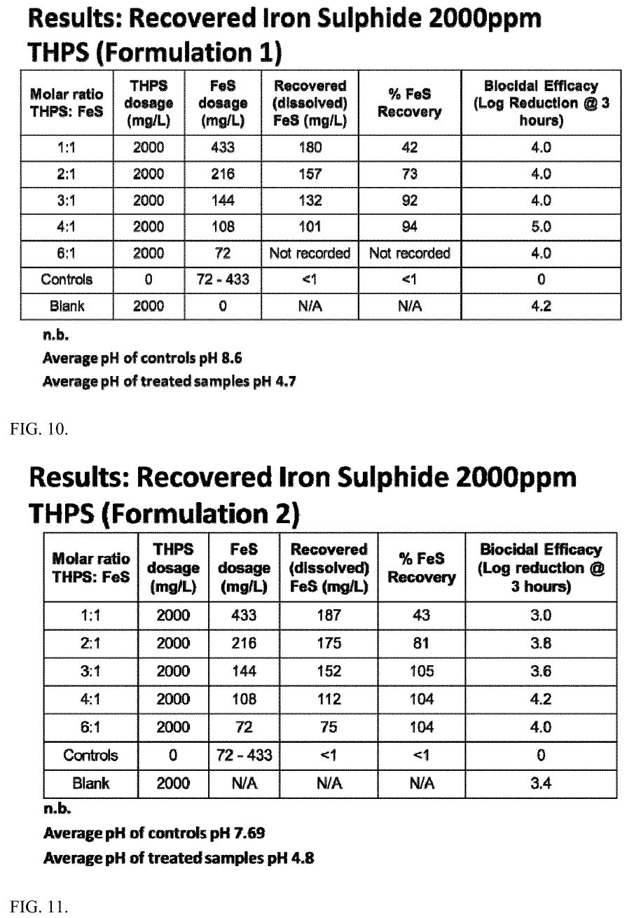

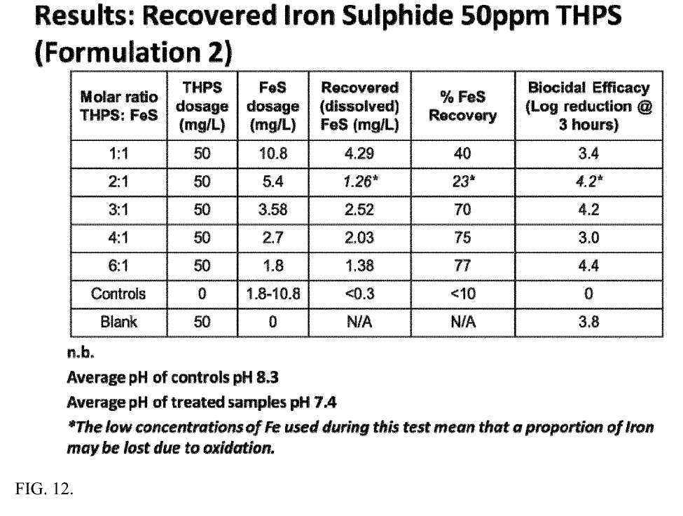

FIGS. 10-12 summarize the results observed for iron sulphide dissolution and biocidal efficacy measured as log reductions in bacterial numbers.

It has been demonstrated that formulations including tris(hydroxymethyl) phosphine (THP) or a tetrakis (hydroxymethyl) phosphonium sulphate (THPS) retain their biocial properties even after having dissolved iron sulphide. Formulation of THPS, in particular when a biopenetrant is added can be used simultaneously for both properties, that is, dissolution of iron sulphide and bacterial control.

In the case of a model colloidal iron sulphide solution, it has been ascertained that the reaction stoichiometry of THPS:Fe is advantageous at between 2:1 and 6:1, and in particular around 3:1 molar ratio.

Furthermore when reactions were completed using this stoichiometry a good recovery of FeS, measured as total soluble iron, was recorded. Typically >70% recovery.

Furthermore, experiments carried out using THPS and iron sulphide, contained in a model system containing general heterotrophic bacteria (GHB) has shown that bacterial kill is still achieved and at a consistent reduction in colony forming units per ml as a control sample that contained no iron sulphide and presence of the same level of tetrakishydroxymethyl phosphonium sulphate.

These findings have significant commercial, regulatory and technical implications related to the deployment of biocides as opposed to iron sulphide dissolvers and chelants.

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

We claim:

1. A process for simultaneously dissolving iron sulphide and killing or inhibiting bacteria present in a hydrocarbon-containing system comprising the step of introducing to the system an aqueous fluid comprising tris(hydroxymethyl) phosphine (THP) or tetrakis (hydroxymethyl) phosphonium salt (THPS), wherein the THP or THPS is introduced in a molar ratio of 1:1 to 6:1 THP or THPS to iron sulphide.

2. The process of claim 1, wherein the aqueous fluid is introduced to the system via continuous addition.

3. The process of claim 1, wherein the aqueous fluid is introduced to the system via shot dosing.

4. The process of claim 1, wherein the bacteria are selected from the group consisting of sulphate-reducing prokaryotes, general heterotrophic bacteria, acid producing bacteria, nitrate-reducing bacteria, and methanogenic archaea.

5. The process of claim 1, wherein the iron sulphide is selected from the group consisting of troilite (FeS), pyrite (FeS₂), mackinawite (Fe₉S₈), phyrrhotite (Fe₇S₈), schmoo, and combinations thereof.

6. The process of claim 1, wherein the aqueous fluid comprises tetrakis (hydroxymethyl) phosphonium salt which has formula THPX, wherein X is chloride, sulphate, bromide, iodide, phosphate, acetate, oxalate, citrate, borate, chlorate, lactate, nitrate, fluoride, carbonate or formate.

7. The process of claim 1, wherein the aqueous fluid further comprises a biopenetrant, a corrosion inhibitor, or a combination thereof.

8. The process of claim 7, wherein the aqueous fluid comprises from 0.05 wt % to 25 wt % of a biopenetrant, a corrosion inhibitor, or a combination thereof.

9. The process of claim 7, wherein the biopenetrant and/or corrosion inhibitor is selected from phosphonate endcapped biopenetrants which comprise a polymer of an unsaturated carboxylic acid or a copolymer of an unsaturated carboxylic acid with a sulphonic acid, said polymer or copolymer being terminated by a mono- or diphosphonated unsaturated carboxylic acid group or having such monomers incorporated into the polymer backbone.

10. The process of claim 1, wherein the THP or THPS is introduced to the system at a concentration of from 1 to 3000 ppm based on the total volume of aqueous fluid added to the system.

11. The process of claim 1, wherein the hydrocarbon-containing system is (a) an oil reservoir or a gas reservoir, (b) a container for storing or processing oil or gas, or (c) a distribution or transmission pipeline for water or hydrocarbons.

12. The process of claim 1 further comprising measuring the number of microorganisms and the level of solid iron sulphide species in the system prior to and after introducing the aqueous fluid to the system, wherein after introduction of the aqueous fluid the number of microorganisms is reduced by at least log 2 and at least 60% iron sulphide species is dissolved.

13. The use of a formulation comprising tris(hydroxymethyl) phosphine or a tetrakis (hydroxymethyl) phosphonium salt to simultaneously dissolve iron sulphide and kill or inhibit the activity of micro-organisms, especially bacteria.
